(19) United States
(12) Patent Application Publication
(10) Pub. No.: US 2004/0085242 A1
(43) Pub. Date: May 6, 2004

(54) Synthetic Doppler system and method for locating cooperative transceivers

(76) Inventors: Nicole Brousseau, Ottawa (CA); Geoffrey Colman, Ottawa (CA); James S. Wight, Ottawa (CA)

Correspondence Address: STITES & HARBISON PLLC, 1199 NORTH FAIRFAX STREET, SUITE 900, ALEXANDRIA, VA, 22314, US

(21) Appl. No.: 10/691,550

(22) Filed: Oct. 24, 2003

Related U.S. Application Data
(60) Provisional application No. 60/422,168, filed on Oct. 30, 2002.

(51) Int. Cl. G01S 1/24

(52) U.S. Cl. 342/387; 342/398

(57) ABSTRACT

A system and a method of locating a co-operative transceiver in an indoor location by setting up multiple transmitting beacons outside of a building in which the transceiver is located. Information at the transceiver, such as time-of-arrival (TOA) or time-difference-of-arrival (TDOA) of the first-to-arrive signals originating from the external beacons, is relayed back to a processing centre. The angle-of-transmission (AOT) is then determined for the first-to-arrive signals, the only ones with a potential for line-of-sight signals, as well as any arriving reflected signals. Synthetic Doppler, by revolving the transmitting antenna, is used to distinguish between a line-of-sight received signal in order to accurately determine the location of the transceiver.

This Application claims the benefit of U.S. Provisional Application No. 60/422,168, filed on Oct. 30, 2002.

### FIELD OF THE INVENTION

The present invention relates generally to a system and a method to determine an accurate location of co-operative transceivers in indoor locations and, in particular, to use synthetic Doppler to distinguish between a line-of-sight received signal from multiple external transmitting beacons and a reflected received signal.

### BACKGROUND OF THE INVENTION

In all forms of geolocation, either indoor or outdoor, there are no known effective techniques at present to determine if a first arrived signal reaching a receiver is a line-of-sight signal or a reflected received signal, i.e. one having one or more reflections from surfaces. This causes a substantial deterioration of the geolocation results since it is impossible to determine if the calculated location is derived from valid line-of-sight signals or from erroneous data originating from reflected received signals.

The accurate location of co-operative transceivers in indoor locations is required in applications such as firefighting. The main challenge for such systems is created by attenuation and reflections formed by the presence of interior and exterior walls as well as floors in multi-story buildings. Although some mitigation of the effects created by the presence of reflected received signals is possible by using techniques such as spatial filtering or other sophisticated signal processing techniques, no effective technique has existed up to present to determine if the first received signal is a line-of-sight or a reflected one.

### SUMMARY OF THE INVENTION

It is an object of the present invention to provide a system and a method for determining the accurate location of co-operative transceivers in indoor locations.

According to one aspect of the invention a transceiver located in an enclosed location wirelessly receives and measures time-of-arrival or time-difference-of-arrival of a first-to-arrive signal originating from each of two or more revolving wireless transmitters generating and transmitting a synthetic Doppler situated outside the enclosed location and relays those measurements wirelessly to a processing centre. The transceiver also determines the angle-of-transmission of a transmitter for a first-to-arrive signal from each transmitter, wherein such signals are the only ones with the potential to be line-of-sight signals, as well as angles-of-transmission for any other arriving reflected signals reflected by any reflecting surfaces in the enclosed location and relays all of those measurements to a processing centre via the transceiver. The processing centre computes a line-of-position from the times-of-arrival or time-differences-of-arrival from the first-to-arrive signal from each transmitter. The location of the transceiver is determined as the intersection of the line-of-position with the intersection of the angles-of-transmission, if the line-of-position intersects with the intersection of the angles-of-transmission, or if no such intersection occurs, the location of the transceiver is determined through an iterative trial and error process that employs the correct angles-of-transmission, knowledge of the location of reflecting surfaces situated within the enclosed location and time-of-arrival or time-difference-of-arrival data assuming various angles of reflection to account for the positions of the known reflecting surfaces, until the times-of-arrival or time-differences of arrival calculated using this method are the same as the times-of-arrival or time-differences of arrival calculated from the signals detected by the transceiver.

According to another aspect of the invention, it provides a method for locating the transceiver using the system of the invention.

### BRIEF DESCRIPTION OF THE DRAWINGS

The invention will now be described in more detail with reference to the accompanying drawings, in which:

FIG. 1 illustrates a general geolocation system according to the present invention wherein multiple transmitting beacons are set up outside a building to track a mobile transceiver's movement within the building,

FIG. 2 illustrates an angle-of-transmission (AOT) detecting system which along with time-of-arrival or time-difference-of arrival information is used to determine the accuracy of an apparent location or determine the actual location of a transceiver according to the present invention,

FIG. 3a illustrates the determination of the angle-of-transmission by simultaneously modulating a carrier with a short spreading code and revolving a transmitting antenna about a horizontal circle to create a synthetic Doppler illustrated in FIG. 3b, and

FIG. 4 is a block diagram of a circuit that can measure the difference in the time of the start of the spreading code (epoch) and the start of a frequency modulation (zero frequency offset).

### DESCRIPTION OF THE PREFERRED EMBODIMENTS

In all forms of geolocation, either indoor or outdoor, there are no known effective techniques at present to determine if a first arrived signal reaching a receiver is an actual line-of-sight signal or a reflected one, i.e. one having one or more reflections from surfaces. This causes a substantial deterioration of the calculated geolocation results since it is impossible to determine if the calculated location is derived from valid line-of-sight signals or from erroneous data originating from reflected received signals.

The accurate location of co-operative transceivers in indoor locations is required in applications such as firefighting. The main challenge for such systems is created by attenuation and reflections formed by the presence of interior and exterior walls as well as floors in multi-story buildings. Although some mitigation of the effects created by the presence of reflected received signals is possible by using techniques such as spatial filtering or other sophisticated signal processing techniques, no effective techniques exists up to present to determine if the first received signal is a line-of-sight or a reflected one.

Methods to overcome the effect of high attenuation focus, in general, on the use of high processing-gain (long integration intervals). One of the most promising techniques for dealing with the effects of reflected signals is to focus on the information contained in the first signal to arrive at the receiver. This signal will have traveled the least distance and, as such, is either a direct path or, at least, the most direct path. The first-to-arrive signal can be sorted out from the remaining reflected signals with the use of a search correlator and of a direct sequence spreading code, the same code that can provide processing gain to overcome high attenuation.

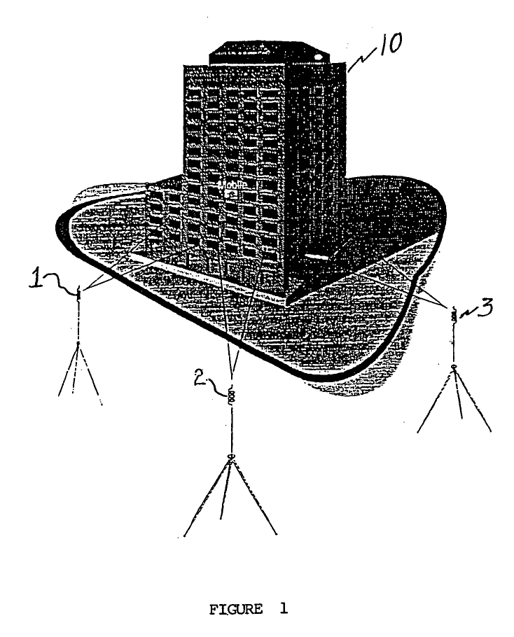

In a co-operative scenario, multiple transmitting beacons 1, 2 and 3 are set up outside a building 10, within which it is desired to track a transceiver's movements as illustrated in FIG. 1. The time-of-arrival (TOA) or time-difference-of-arrival (TDOA) of the first-to-arrive signal can be determined by a search correlator processing a direct sequence spreading code. It is also possible to evaluate the angle-of-transmission (AOT) from a beacon associated with a particular reflected path by using Doppler techniques. The AOT and either the TOA or TDOA of the first-to-arrive signal originating from the external beacons measured by the mobile transceiver are relayed back to a processing centre to determine the location of the mobile transceiver from that data.

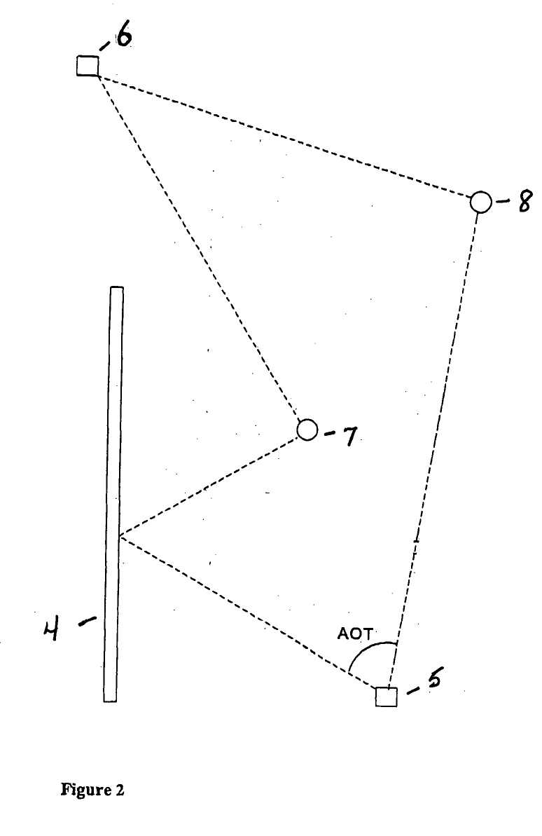

FIG. 2 illustrates how the AOT is used with the TOA or TDOA information to determine the validity of an apparent location of a mobile transceiver 8 or to determine the actual location of the mobile transceiver 7. A line-of-position is computed from the TOA or TDOA of the first-to-arrive signal from each transmitter. If the AOTs intersect the line-of-position, then a direct path has been achieved, i.e. the one between transmitter beacon 6 and the actual location of mobile transceiver 7. If the AOTs do not intersect the line-of-position, then a reflection has occurred and an invalid computed location 8 results. This is illustrated by the path from transmitting beacon 5 reflecting from wall 4 to the actual location of the mobile transceiver 7, which results in a longer path between 5 and 7. Without the AOT information, the apparent location of the mobile transceiver would then be somewhere around 8.

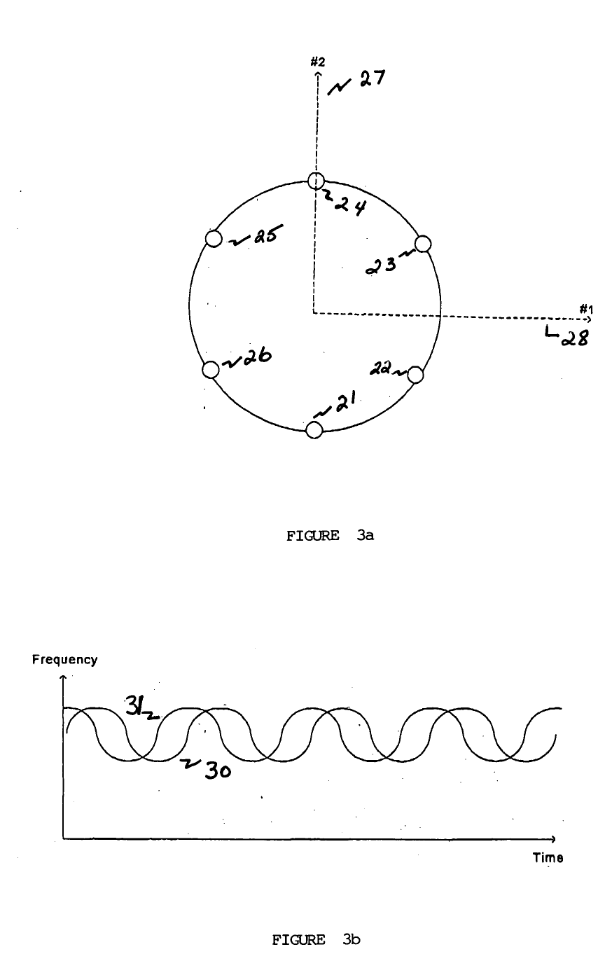

The AOT to different observers at 27 and 28 in FIG. 3a can be provided by simultaneously modulating a carrier with a short spreading code and revolving the transmitting antenna about a horizontal circle such that the position of the transmitting antenna moves around the circle from position 21 to 26 and back to 21 in FIG. 3a at various points in time. This creates a synthetic Doppler wherein the AOTs of observers 27 and 28 in FIG. 3a correspond to frequencies 30 and 31, in FIG. 3b, respectively. The period of the short spreading code and the time for one revolution are integrally related. The simplest relationship is to have them be equal. The instantaneous Doppler on the transmitted signal will be different for all AOTs but the instantaneous code phase will be identical.

A reference direction can be established at the transmitter based on a relationship between the code epoch and the reference Doppler. For example, the start of the code sequence (code epoch) and the maximum positive Doppler shift can be set to occur simultaneously for a specified direction. For all other directions, the time of occurrence of the code epoch and the maximum positive Doppler will differ. This time difference (phase difference) is directly proportional to the angle offset or AOT with respect to the reference direction.

To realize the Doppler shift, a single antenna can actually be quickly revolved in a circle. Alternatively, a virtually revolved transmitting antenna can be realized by sequentially switching the transmitted signal to one of at least three identical antennas arranged in a circle.

With prior knowledge of the positions of a building's walls and furniture layout, the locations of the first reflections of the first-to-arrive signals (one from each transmitter beacon) can be determined since their AOTs are known. Using the known locations of the first reflections, a new calculation for the transceiver is performed. If no further reflections are encountered (for the first-to-arrive signals only), then this calculation also gives the actual location of the mobile transceiver. If a valid location cannot be determined in this manner, then the procedure is continued for subsequent reflection points, until a valid location is determined.

It should be noted that, if the direction of a receiver contains a vertical component, such as in a multi-story building, the peak-to-peak Doppler shift would be reduced by the cosine of the elevation. This feature is useful in determining the floor location of the receiver.

Alternatively, a more accurate approach is to rotate the axis of (virtual) revolution of the antenna to a horizontal direction. Assuming the orientation of this axis to be at right angles with respect to the azimuthal AOT, the elevation can be accurately measured using the same time difference of occurrence of the code epoch and the maximum positive Doppler shift. In this situation, the external stations performing the calculations must be made aware of the current axis direction in order to correctly determine the location of the receiver.

For the synthetic Doppler, the instantaneous radian-frequency of a signal that has sinusoidal frequency modulation applied to it is given by:

ωᵢₙₛₜ=ω+ΔωCOS (Ωt) (1)

where ωᵢₙₛₜ is the instantaneous radian-frequency

ω is the nominal radian-frequency

Δω is the peak radian-frequency deviation and

Ω is the radian-frequency of modulation

When this instantaneous radian-frequency is integrated to obtain the instantaneous radian angle, the signal can be expressed as:

S₍ₜ₎=A sin {ωt+[Δω/Ω] sin (Ωt)} (2)

where A is the signal amplitude.

When the sinusoidal frequency modulation is generated, by revolving a transmitting antenna about a vertical axis, i.e. in a circle to create Doppler shifts, the signal will include an azimuth dependent term:

S₍ₜ₎=A sin {ωt+[Δω/Ω] sin (Ωt−Az)} (3)

where: Az is the azimuth direction (in radians).

A binary direct sequence spreading code can be expressed as:

c(t)=Σk {aₖp(t−KT_{c})} (4)

where: c(t) is the binary direct sequence code

aₖ is the K^{th} chip value (either +1 or −1)

p(t-KT_{c}) is the chip waveform (usually a rectangular function) and

T_{c}, is the chip duration.

This spreading code will have a period of P=MT_{c}, where M is the number of chips in the sequence. After a sequence is completed, it will repeat itself

The spreading code can be applied to the sinusoidal frequency modulated signal:

$$\begin{matrix}S ( t ) = Ac ( t ) sin \{ ω t + [ Δ ω / Ω ] sin ( Ω t - Az ) \} \\ = A {\sum }_{k}^{} \{ {a}_{k} p ( t - {KT}_{c} ) \} sin \{ ω t + [ Δ ω / Ω ] sin ( Ω t - Az ) \}\end{matrix} \qquad ( 5 )$$

The period of the spreading code MT_{c} can be constrained to have the same value as that of the sinusoidal frequency modulation ½πω. In this situation the difference in time of the start of the spreading code (epoch) and the start of the frequency modulation (zero frequency offset) can be measured at a receiver and used to solve the azimuth direction A_{z} to the receiver.

An arbitrary direction (such as North) can be assigned, such that a receiver in that direction with respect to the transmitter will receive both the spreading code epoch and the frequency modulation zero frequency offset at the same time.

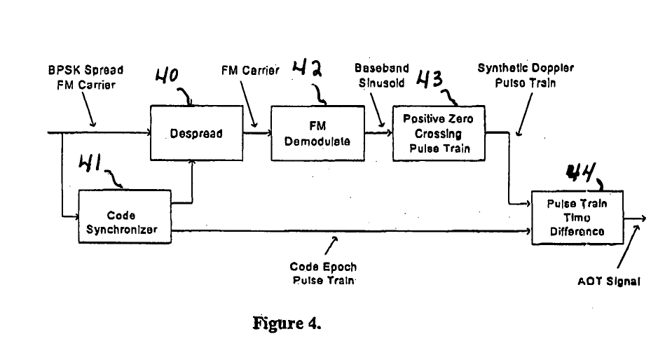

A block diagram implementation that measures the difference in the time of the start of the spreading code (epoch) and the start of the frequency modulation (zero frequency offset) is illustrated in FIG. 4. In FIG. 4, the incoming BPSK spread FM carrier is applied to a code synchronizer 41 where a stored reference code is synchronized to the incoming direct sequence spreading code, using either a real time correlator or a delay-locked loop. The output of the synchronizer 41 is used to provide both a pulse-train corresponding to the spreading code-epoch and to de-spread the incoming signal at 40 resulting in an FM carrier.

The FM carrier is then demodulated in a phase locked discriminator (FM demodulator 42) producing a baseband-sinusoid that corresponds to the instantaneous synthetic Doppler on the radio carrier. The positive zero crossings of the baseband-sinusoid are converted to a pulse-train at 43 and the time difference between the pulses of the pulse-train and those of the code-epoch pulse-train obtained at 44 yields the angle-of-transmission information. This information can be computed in a processor or determined with analog circuits.

It is to be understood that the embodiments and variations shown and described herein are merely illustrations of the principles of this invention and that various modifications may be implemented by those skilled in the art without departing from the spirit and scope of the invention.

What is claimed is:

1. A system for locating a transceiver in an enclosed location, comprising:
(i) a transceiver in an enclosed location operable to receive signals wirelessly, for measuring times-of-arrival of first-to-arrive signals or time-differences-of-arrival of first-to-arrive-signals, and for measuring angles-of-transmission for first-to-arrive signals from two or more transmitters, wherein such signals are the only ones with the potential to be line-of-sight signals, and also for measuring angles-of-transmission for any other arriving signals reflected by any reflecting surfaces in the enclosed location and to transmit the measurements by wireless means;
(ii) two or more revolving wireless transmitters situated outside the enclosed location operable to generate and transmit a synthetic Doppler; and
(iii) a processing centre operable to receive signals wirelessly from the transceiver and to compute and compare a line-of-position from time-of-arrival or time-difference-of-arrival data from the first-to-arrive signal from each transmitter with the angles-of-transmission and to determine the location of the transceiver as the intersection of the line-of-position with the intersection of the angles-of-transmission, if the line-of-position intersects with the intersection of the angles-of-transmission, or if no such intersection occurs, to determine the location of the transceiver through an iterative trial and error process that employs the correct angles-of-transmission, knowledge of the location of reflecting surfaces situated within the enclosed location and time-of-arrival or time-difference-of-arrival data assuming various angles of reflection to account for reflecting surfaces, until the times-of-arrival or time-differences-of-arrival calculated using this method are the same as the times-of-arrival or time-differences-of-arrival calculated from the signals detected by the transceiver.

2. The system of claim 1, wherein each of the two or more transmitters generates signals comprised of an electromagnetic carrier wave modulated by a short spreading code.

3. The system of claim 2, wherein the processing centre computes a line-of-position for the transceiver from the time-of-arrival or time-difference-of-arrival of the first-to-arrive signals at the transceiver from each of the two or more transmitters as computed from the phase difference of the start of the short spreading code sequence, also known as the code epoch, of the two or more signals detected by the transceiver.

4. The system of claim 3, wherein the transmitters establish a reference direction through the definition of a relationship between the code epoch and the reference Doppler shift, and the angle-of-transmission of each transmitter is computed from the phase difference between the code epoch and the reference Doppler detected by the transceiver for each transmitter.

5. The system of claim 3, wherein, if the direction of the transceiver contains a vertical component, the processing centre computes the vertical component directly based on the reduction of the Doppler shift by the cosine of the elevation.

6. The system of claim 3, where the axis of revolution of a transmitter is rotated in a horizontal direction and the processing centre computes the elevation of the transceiver using the corresponding time-difference-of occurrence of the code epoch and reference Doppler shift.

7. The system of claim 3, wherein the two or more transmitters situated at known locations outside the enclosed location are revolved about a horizontal circle at a periodic rate that is integrally related to the spreading code duration while each transmitter radiates the modulated signal in order to achieve the synthetic Doppler.

8. The system of claim 4, wherein the two or more transmitters situated at known locations outside the enclosed location are revolved about a horizontal circle at a periodic rate that is integrally related to the spreading code duration while each transmitter radiates the modulated signal in order to achieve the synthetic Doppler.

9. The system of claim 5, wherein the two or more transmitters situated at known locations outside the enclosed location are revolved about a horizontal circle at a periodic rate that is integrally related to the spreading code duration while each transmitter radiates the modulated signal in order to achieve the synthetic Doppler.

10. The system of claim 3, wherein the transmitter is virtually revolved by sequentially switching the transmitted signal in turn to each of at least three identical antennas arranged in a circle, instead of revolving the transmitter itself in order to realize the Doppler shift.

11. The system of claim 4, wherein the transmitter is virtually revolved by sequentially switching the transmitted signal in turn to each of at least three identical antennas arranged in a circle, instead of revolving the transmitter itself in order to realize the Doppler shift.

12. The system of claim 5, wherein the transmitter is virtually revolved by sequentially switching the transmitted signal in turn to each of at least three identical antennas arranged in a circle, instead of revolving the transmitter itself in order to realize the Doppler shift.

13. The system of claim 1, wherein the enclosed location is the inside of a building.

14. A method of locating a transceiver in an enclosed location comprising:
(i) receiving wirelessly and measuring, via the transceiver, times-of-arrival or time-differences-of-arrival of first-to-arrive signals originating from each of two or more revolving wireless transmitters generating and transmitting a synthetic Doppler situated outside the enclosed location and relaying those measurements wirelessly to a processing centre via the transceiver;
(ii) determining, via the transceiver, angles-of-transmission of the transmitters for first-to-arrive signals from each transmitter, wherein such signals are the only ones with the potential to be line-of-sight signals, as well as angles-of-transmission for any other arriving signals reflected by any reflecting surfaces in the enclosed location and relaying those measurements to a processing centre via the transceiver;
(iii) computing and comparing, via the processing centre, a line-of-position from time-of-arrival or time-difference-of-arrival data from the first-to-arrive signal from each transmitter with the angles-of-transmission; and
(iv) determining the location of the transceiver as the intersection of the line-of-position with the intersection of the angles-of-transmission, if the line-of-position intersects with the intersection of the angles-of-transmission, or if no such intersection occurs, determining the location of the transceiver through an iterative trial and error process that employs the correct angles-of-transmission, knowledge of the location of reflecting surfaces situated within the enclosed location and time-of-arrival or time-difference-of-arrival data assuming various angles of reflection to account for the positions of the known reflecting surfaces, until the times-of-arrival or time-differences-of-arrival calculated using this method are the same as the times-of-arrival or time-differences-of-arrival calculated from the signals detected by the transceiver.

15. The method of claim 14, wherein each signal originating from a transmitter is comprised of an electromagnetic carrier wave modulated by a short spreading code.

16. The method of claim 15, wherein the line-of-position is computed for the transceiver by the processing centre from the time-of-arrival or time-difference-of-arrival of the first-to-arrive signals at the transceiver from each of the two or more transmitters as computed from the code epoch of the two or more signals detected by the transceiver.

17. The method of claim 16, wherein a reference direction is established by the transmitters through the definition of a relationship between the code epoch and the reference Doppler shift, and the angle-of-transmission of each transmitter is computed from the phase difference between the code epoch and the reference Doppler detected by the transceiver for each transmitter.

18. The method of claim 17, wherein, if the direction of the transceiver contains a vertical component, the said vertical component is computed by the processing centre directly based on the reduction of the Doppler shift by the cosine of the elevation.

19. The method of claim 17, wherein the axis of revolution of the transmitter is rotated in a horizontal direction and the elevation of the transceiver is computed by the processing center using the corresponding time-difference-of occurrence of the code epoch and reference Doppler shift.

20. The method of claim 17, wherein the synthetic Doppler is achieved by revolving the two or more transmitters situated at known locations outside the enclosed location about a horizontal circle at a periodic rate that is integrally related to the spreading code duration while each transmitter radiates the modulated signal.

21. The method of claim 18, wherein the synthetic Doppler is achieved by revolving the two or more transmitters situated at known locations outside the enclosed location about a horizontal circle at a periodic rate that is integrally related to the spreading code duration while each transmitter radiates the modulated signal.

22. The method of claim 19, wherein the synthetic Doppler is achieved by revolving the two or more transmitters situated at known locations outside the enclosed location about a horizontal circle at a periodic rate that is integrally related to the spreading code duration while each transmitter radiates the modulated signal.

23. The method of claim 17, wherein the Doppler shift is realized by a virtually revolved transmitter by sequentially switching the transmitted signal in turn to each of at least three identical antennas arranged in a circle, instead of revolving the transmitter itself

24. The method of claim 18, wherein the Doppler shift is realized by a virtually revolved transmitter by sequentially switching the transmitted signal in turn to each of at least three identical antennas arranged in a circle, instead of revolving the transmitter itself

25. The method of claim 19, wherein the Doppler shift is realized by a virtually revolved transmitter by sequentially switching the transmitted signal in turn to each of at least three identical antennas arranged in a circle, instead of revolving the transmitter itself

26. The method of claim 14, wherein the enclosed location is the inside of a building.
